(19) United States
(12) Patent Application Publication
(10) Pub. No.: US 2018/0207969 A1
(43) Pub. Date: Jul. 26, 2018

(54) PRINTING PLATE, SUBSTRATE, AND PRINTING METHOD

(71) Applicant: FUJITSU COMPONENT LIMITED, Tokyo (JP)

(72) Inventor: Hiroki SATO, Tokyo (JP)

(73) Assignee: Fujitsu Component Limited, Tokyo (JP)

(21) Appl. No.: 15/744,323

(22) PCT Filed: Jul. 7, 2016
(86) PCT No.: PCT/JP2016/070118

§ 371 Date: Jan. 12, 2018

(30) Foreign Application Priority Data
Jul. 23, 2015 (JP) 2015-146071

(51) Int. Cl. B41M 1/10; B41M 1/40; B41N 1/06

(52) U.S. Cl. CPC B41M 1/10; B41N 1/06; B41M 1/40

(57) ABSTRACT

A printing plate having a recessed area to be filled with a print material to be transferred to a substrate includes at least one step situated in at least part of the recessed area and having a different depth than a bottom face of the recessed area.

### TECHNICAL FIELD

The disclosures herein relate to a printing plate, a substrate, and a printing method.

### BACKGROUND ART

In pad printing known in the art, ink deposited in a recessed area formed in a printing plate is transferred to a pad, and the ink transferred on the pad is then transferred to a substrate, thereby printing, on the surface of the substrate, characters or symbols corresponding to the shape of the recessed area of the printing plate. A method of such pad printing that forms a plurality of recessed areas in a printing plate to print a mark having a plurality of constituent elements, for example, is known in the art (see Patent Document 1, for example).

### RELATED-ART DOCUMENTS

### Patent Document

### [Patent Document 1] Japanese Patent Application Publication No. 2002-362001

### SUMMARY OF THE INVENTION

### Problem to be Solved by the Invention

In pad printing described above, recesses in a printing plate are generally formed such as to have a constant depth from the plate surface.

FIG. 11 is a drawing illustrating an example of a printing plate 500. The printing plate 500 illustrated in FIG. 11 as an example has a recessed area 520 formed to take the shape of a letter “A”. The recessed area 520 is formed such as to have a constant depth from a plate surface 510.

FIG. 12 is a drawing illustrating an example of a printed deposit 530 printed by use of the printing plate 500 shown in FIG. 11. As is illustrated in FIG. 12, the printed deposit 530 formed by transferring to a substrate the ink deposited in the recessed area 520 having a constant depth has a constant height from the print surface, thereby having an entirely even density.

In order to improve the design, gradation may be created within the same printed deposit. In such a case, a plurality of printing plates with recessed areas having different depths may be prepared, and a plurality of printing processes may be performed on one substrate. Such a method, however, may entail an increase in printing costs due to an increase in the number of printing steps.

In consideration of this, it may be desired to provide a printing plate capable of readily forming a printed deposit having gradation.

### Means to Solve the Problem

According to an embodiment, a printing plate having a recessed area to be filled with a print material to be transferred to a substrate includes at least one step situated in at least part of the recessed area and having a different depth than a bottom face of the recessed area.

### Advantage of the Invention

According to at least one embodiment, a printing plate capable of readily forming a printed deposit having gradation is provided.

### BRIEF DESCRIPTION OF DRAWINGS

FIG. 1 is a drawing illustrating an example of a printing plate according to an embodiment.

FIG. 2A is an axonometric cross-sectional view illustrating an example of the printing plate according to the embodiment.

FIG. 2B is a cross-sectional view illustrating an example of the printing plate according to the embodiment.

FIG. 3A is a drawing illustrating an example of a printing method according to an embodiment.

FIG. 3B is a drawing illustrating the example of a printing method according to the embodiment.

FIG. 3C is a drawing illustrating the example of a printing method according to the embodiment.

FIG. 3D is a drawing illustrating the example of a printing method according to the embodiment.

FIG. 3E is a drawing illustrating the example of a printing method according to the embodiment.

FIG. 4 is a drawing illustrating an example of a printed deposit according to the embodiment.

FIG. 5A is an axonometric cross-sectional view illustrating the example of a printed deposit according to the embodiment.

FIG. 5B is a cross-sectional view illustrating the example of a printed deposit according to the embodiment.

FIG. 6 is a plan view illustrating the example of a printed deposit according to the embodiment.

FIG. 7A is a drawing illustrating a printing method according to a first comparative example.

FIG. 7B is a drawing illustrating the printing method according to the first comparative example.

FIG. 8A is a drawing illustrating a printing method according to a second comparative example.

FIG. 8B is a drawing illustrating the printing method according to the second comparative example.

FIG. 9 is a drawing illustrating an example of a keycap according to an embodiment.

FIG. 10 is a drawing illustrating the example of a keycap according to an embodiment.

FIG. 11 is a drawing illustrating an example of a printing plate.

FIG. 12 is a drawing illustrating an example of a printed character.

FIG. 13 is a cross-sectional view illustrating an example of a keycap.

### MODE FOR CARRYING OUT THE INVENTION

In the following, embodiments will be described by referring to the accompanying drawings. In these drawings, the same elements are referred to by the same references, and a description thereof may be omitted.

### <Printing Plate>

A printing plate of a present embodiment will be described first.

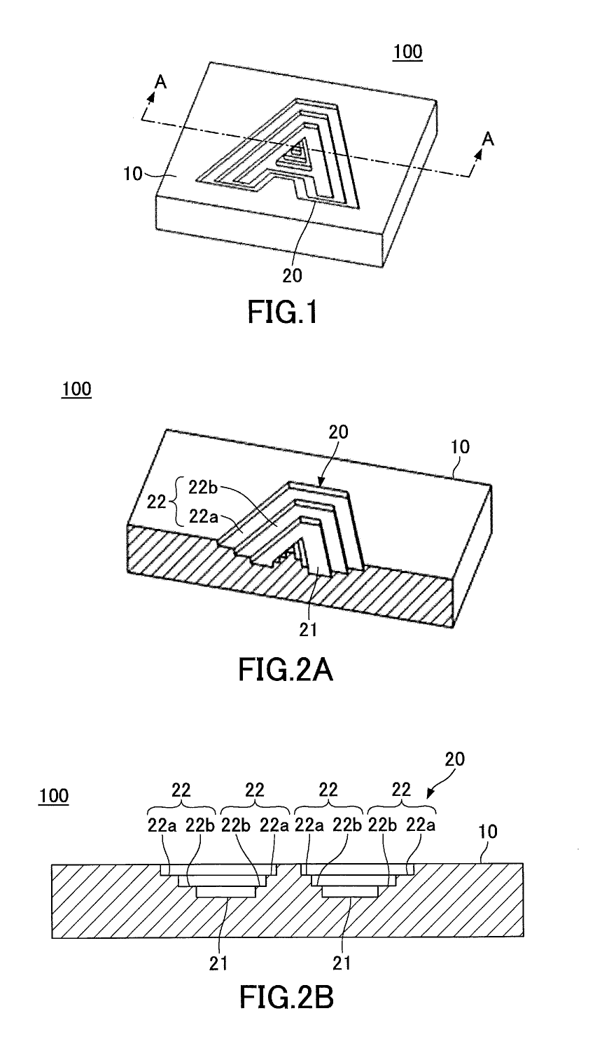

FIG. 1 is a drawing illustrating an example of a printing plate 100 according to an embodiment. FIGS. 2A and 2B are drawings illustrating a cross-section taken along the line A-A in FIG. 1. FIG. 2A is an axonometric cross-sectional view of the printing plate 100, and FIG. 2B is a cross-sectional view of the printing plate 100.

The printing plate 100 illustrated in FIG. 1 and FIGS. 2A and 2B has a recessed area 20 formed to take the shape of a letter “A” on a plate face 10. The recessed area 20 has a plurality of faces formed at different depths from the plate face 10. As is understood from FIGS. 2A and 2B, the recessed area 20 has steps 22 like a set of stairs comprised of a first step 22a and a second step 22b. The steps 22 include at least one step having a depth different from that of a bottom face 21 of the recessed area 20. The recessed area 20 is formed such that its depth gradually increases away from the plate face 10 in the following order: the first step 22a, the second step 22b, and the bottom face 21. Such an arrangement ensures that the depth does not exhibit a significant change between steps.

The recessed area 20 is formed by etching. In order to form the recessed area 20 having faces at different depths as illustrated in FIG. 1 and FIGS. 2A and 2B, a plurality of etching processes are performed with respect to the printing plate 100 according to the present embodiment. In the recessed area 20, a first etching process is performed while the areas of the plate face 10 other than the recessed area 20 are masked, thereby carving the plate up to the depth of the first step 22a. Then, a second etching process is performed while the plate face 10 and part of the bottom surface at the depth of the first step 22a are masked, thereby carving the recessed area 20 up to the depth of the second step 22b. Subsequently, a third etching process is performed while the plate face 10, the first step 22a, and part of the bottom surface at the depth of the second step 22b are masked, thereby carving the recessed area 20 up to the depth of the bottom face 21. These processes serve to form in the printing plate 100 the recessed area 20 that takes the shape of a single letter comprised of a plurality of faces situated at respective different depths.

In this manner, a plurality of etching processes are performed to form the recessed area 20, so that the recessed area 20 having a plurality of faces at different depths is readily formed in the printing plate 100 with high dimensional precision. In the example illustrated in FIG. 1 and FIGS. 2A and 2B, three faces are formed in the recessed area 20. However, the number of faces is not limited to this example. Further, the recessed area 20 may alternatively be formed by other methods such as engraving.

### <Printing Method>

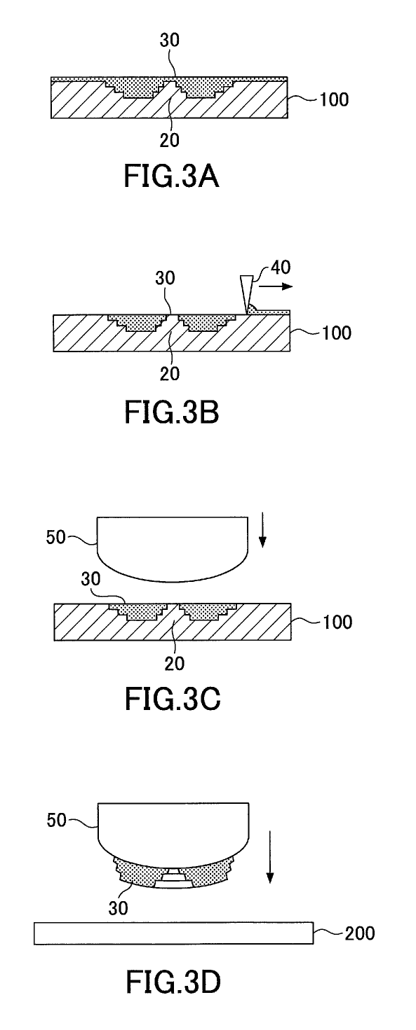

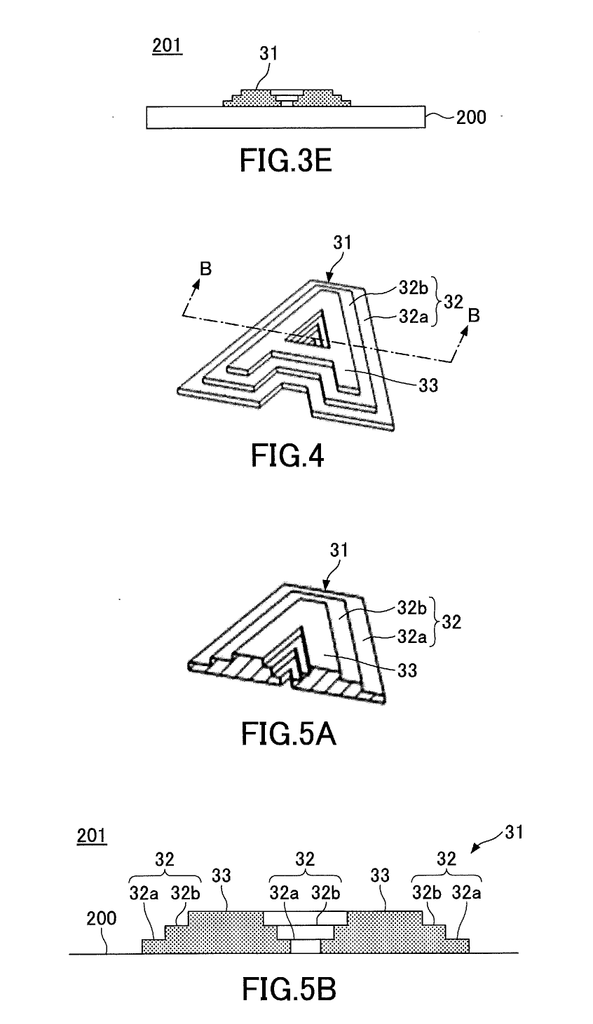

In the following, a printing method using the printing plate 100 described above will be described with reference to FIGS. 3A through 3E. In so doing, an example of pad printing will be described.

In the printing method according to the present embodiment, ink 30 serving as a printing agent is applied to the printing plate 100 as illustrated in FIG. 3A. As a result, the recessed area 20 is filled with the ink 30.

As illustrated in FIG. 3B, a blade 40 is then moved over the surface of the printing plate 100 while placed in contact with the surface, thereby removing excess ink from the printing plate 100. Scraping the ink 30 off the surface by use of the blade 40 leaves only the ink 30 deposited inside the recessed area 20 of the printing plate 100.

Subsequently, as illustrated in FIG. 3C, a pad 50 serving as a transfer body is pressed onto the recessed area 20 of the printing plate 100, thereby transferring the ink 30 deposited in the recessed area 20 to the surface of the pad 50. The pad 50, which may be made of an elastic material such as a silicon rubber, elastically deforms upon being pressed onto the printing plate 100 or onto a substrate.

Thereafter, as illustrated in FIG. 3D, the pad 50 having the ink 30 of the recessed area 20 attached thereto is pressed onto a surface of a substrate 200. With this, the ink 30 is transferred from the pad 50 to the substrate 200. As the transferred ink 30 dries to adhere to the surface of the substrate 200, a printed deposit 31 having the same shape as the recessed area 20 of the printing plate 100 is formed on the surface of the substrate 200, as illustrated in FIG. 3E.

Using the printing plate 100 having the recessed area 20 that takes the shape of a letter “A” as described above to perform printing by use of the method described above enables the provision of a print object 201 having the printed deposit 31 of a letter “A” formed on the surface of the substrate 200.

Here, the term “printed deposit” refers to a deposit formed on the surface of a substrate by transferring a print material such as ink deposited in a recessed area formed in a printing plate. Printing by use of a printing plate having a single recessed area, for example, causes a single printed deposit corresponding to such a recessed area to be formed on the surface of the substrate. Printing by use of a printing plate having a plurality of recessed areas, for example, causes a plurality of printed deposits corresponding to such recessed areas to be formed on the surface of the substrate.

It may be noted that process steps different from the above-described steps may be used for printing as long as the ink 30 deposited in the recessed area 20 of the printing plate 100 can be transferred to the surface of the substrate 200. For example, the pad 50 may not be used, and, instead, the ink 30 may directly be transferred to the surface of the substrate 200 from the recessed area 20 of the printing plate 100.

### <Ink Deposit>

In the following, the printed deposit 31 printed by use of the printing plate 100 will be described with reference to FIG. 4 through FIG. 6.

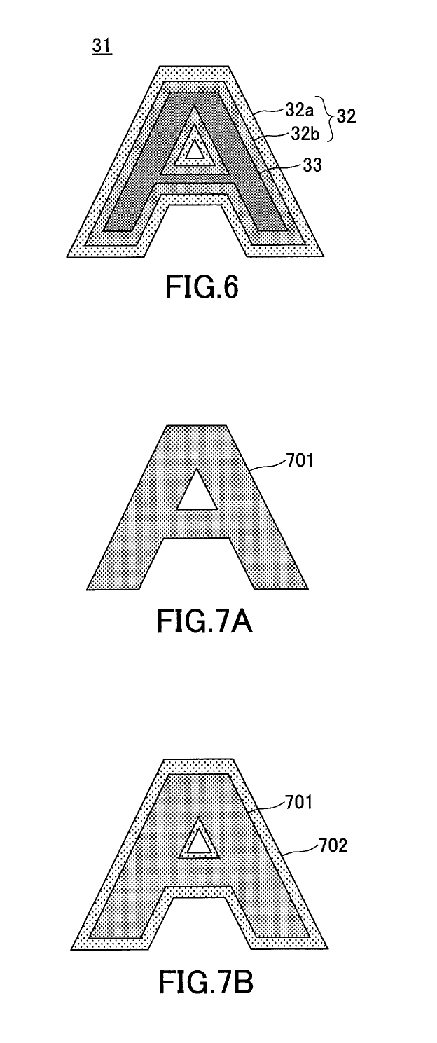

FIG. 4 is a drawing illustrating an example of the printed deposit 31 according to an embodiment. FIGS. 5A and 5B are drawings illustrating a cross-section taken along the line B-B in FIG. 4. FIG. 5A is an axonometric cross-sectional view of the printed deposit 31, and FIG. 5B is a cross-sectional view of the printed deposit 31. FIG. 6 is a plan view illustrating an example of the printed deposit 31 according to the embodiment.

As illustrated in FIG. 4, the printed deposit 31 is formed to take the shape of the same letter “A” as the recessed area 20 of the printing plate 100. Further, as illustrated in FIG. 5, the outlines of the printed deposit 31 (i.e., the outer perimeter of the letter or the like formed by the printed deposit 31 and the inner perimeter formed by closed-loop lines inside the letter or the like) have printed steps 32 corresponding to the steps 22 formed in the recessed area 20 of the printing plate 100. The printed steps 32 include at least one step having a different height than the topmost face of the printed deposit 31. The printed steps 32 are formed such that the thickness of the ink (i.e., the vertical rise from the surface of the substrate 200) increases away from the surface of the substrate 200 in the following order: a first step 32a, a second step 32b, and a topmost step 33.

The printing plate 100 illustrated in FIG. 1 and FIGS. 2A and 2B has the deepest point at the location where the bottom face 21 is formed, so that the amount of ink 30 deposited at this location is the greatest. In contrast, the first step 22a of the recessed area 20 is the shallowest face in the recessed area 20, so that the amount of ink 30 deposited at this location is the smallest. In this manner, the amount of ink 30 deposited in the recessed area 20 decreases in the following order: the bottom face 21->the second step 22b->the first step 22a.

The topmost step 33 of the printed deposit 31 illustrated in FIG. 4 through FIG. 6 corresponds to the bottom face 21 of the recessed area 20 in the printing plate 100, so that the printed thickness is the greatest. In contrast, the first step 32a of the printed deposit 31 corresponds to the first step 22a of the recessed area 20, so that the printed thickness is the smallest.

The portion of the printed deposit 31 having a great printed thickness creates a high print density due to the large amount of ink, and the portion having a small printed thickness creates a low print density due to the small amount of ink. Accordingly, the printed deposit 31 of the present embodiment has the highest print density at the location corresponding to the topmost step 33, and the print density decreases at other locations corresponding to the second step 32b and the first step 32a in this order.

As described above, the printed deposit 31 is formed such that print density increases in the following order: the first step 32a, the second step 32b, and the topmost step 33 as illustrated in FIG. 6, so that the perimeter areas have multi-stage gradation formed therein.

The use of the printing plate 100 according to the present embodiment enables a single printing process to readily form the printed deposit 31 having different densities as described above.

The recessed area 20 of the printing plate 100 is not limited to the shape that was used as an example in the present embodiment, and may be formed to take any desired shape corresponding to a character or symbol to be printed. In the embodiment described above, further, the steps 22 are formed along the entirety of the outlines (i.e., the outer perimeter of a letter or the like formed by the recessed area 20 and the inner perimeter formed by closed-loop lines inside the letter or the like) of the recessed area 20 in the printing plate 100. Alternatively, the steps 22 may be formed at only a part of the outlines of the recessed area 20 so as to create gradation at only a part of the printed deposit. The position at which the steps 22 are formed is not limited to the outlines of the recessed area 20. For example, the steps 22 may be formed near the center of the recessed area 20 such that the density decreases from the outlines of a letter or the like toward the center. Further, a set of the steps 22 is not limited to a two-step configuration comprised of the first step 22a and the second step 22b, and may alternatively be a one-step configuration or comprised of three or more steps such as to create multi-step gradation on a printed deposit.

### First Comparative Example

FIGS. 7A and 7B are drawings illustrating a printing method according to a first comparative example. The printing method of the first comparative example uses a plurality of inks of different colors and a plurality of printing plates with recessed areas having different shapes to perform a plurality of printing processes, thereby forming a printed deposit having gradation.

A printing plate with a recessed area taking the shape of a letter “A” is first used, with ink deposited in the recessed area for printing, thereby forming a printed deposit 701 taking the shape of a letter “A” on the surface of a substrate as illustrated in FIG. 7A.

A printing plate with a recessed area taking such a shape as to add fringes to the printed deposit 701 is then used, with ink deposited in the recessed area and having a different color than the printed deposit 701, thereby printing over the printed deposit 701. As a result, a printed deposit 702 is formed around the printed deposit 701 as illustrated in FIG. 7B.

In this manner, a plurality of printing processes are performed by using a plurality of inks of different colors and using a plurality of printing plates with recessed areas having different shapes, thereby forming a letter or symbol having gradation as illustrated in FIG. 7B.

Alternatively, the depth of the recessed area of the printing plate for forming the printed deposit 702 may be made shallower than the recessed area of the printing plate for forming the printed deposit 701, thereby allowing the same ink to be used to form the printed deposit 701 and the printed deposit 702. In such a case, the thickness of the printed deposit 702 becomes shallower than the thickness of the printed deposit 701. The amount of ink at the position of the printed deposit 702 smaller than the amount of ink at the position of the printed deposit 701 enables the formation of a letter or symbol having gradation.

The printing method of the first comparative example described above requires a plurality of printing processes to be performed by use of a plurality of printing plates with recessed areas having different shapes, which may lead to an increase in process steps and an increase in printing costs.

### Second Comparative Example

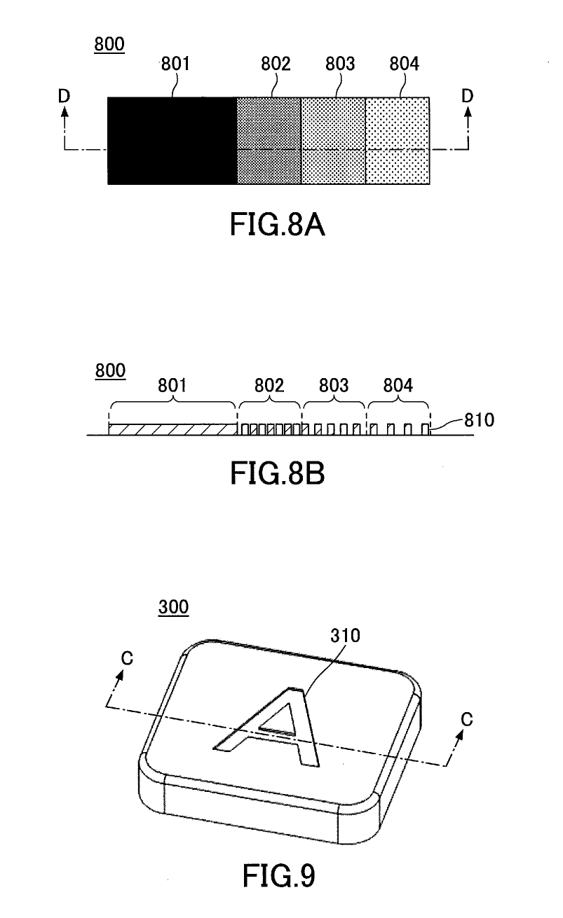

FIGS. 8A and 8B are drawings illustrating a printing method according to a second comparative example. FIG. 8A is a drawing illustrating an example of a printed deposit 800 formed on a surface of a substrate. FIG. 8B is a drawing illustrating a cross-section taken along the line D-D in FIG. 8A. The printing method of the second comparative example forms the printed deposit 800 having gradation by changing dot density on an area-specific basis.

As illustrated in FIGS. 8A and 8B, the density of dots 810 constituting the printed deposit 800 decreases in the following order: an area 801, an area 802, an area 803, and an area 804. Printing in such a manner allows the printed deposit 800 to be formed such that the density gradually changes from the darkest-tone area 801 to the lightest-tone area 804.

The above-described method gives rise to a problem in that the dots 810 become conspicuous as the density of the dots 810 is decreased to provide lighter tones, failing to provide an even tone across the entire area.

### <Keycap>

In the following, a keycap serving as an example of a substrate will be described with reference to the accompanying drawings. The keycap described in the following may be used for a keyboard for a PC or as a button of various kinds for a portable phone, a calculator, or the like.

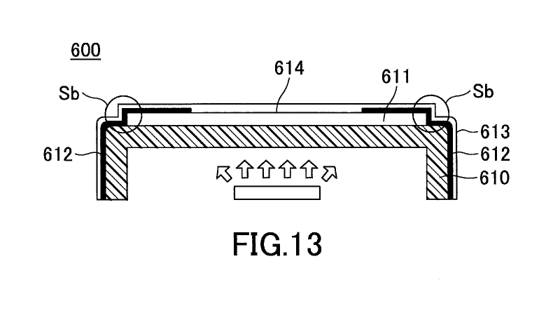

FIG. 13 is a drawing illustrating an example of a keycap 600 with a printed layer having a uniform printed thickness formed on a frame 610.

The keycap 600 illustrated in FIG. 13 includes the frame 610, a printed layer 611 formed on the upper face of the frame 610, a light blocking layer 612 covering the printed layer 611, and a coating layer 613 covering the printed layer 611 and the light blocking layer 612.

The printed layer 611, which is made of a print material allowing light to pass through, is formed on the entire upper face of the frame 610. The light blocking layer 612 is made of a black paint or the like. Specifically, the paint is applied or printed to cover the entirety of the frame 610 and the printed layer 611, followed by removing the paint at the position of a character portion 614 taking the shape of a letter or the like to form the light blocking layer 612. The coating layer 613, which is made of a material such as a transparent resin allowing light to pass through, is formed to cover the light blocking layer 612 and the printed layer 611 exposed through the light blocking layer 612.

The keycap 600 is such that light emitted from a light source disposed under the frame 610, for example, passes through the frame 610, the printed layer 611, and the coating layer 613. With this arrangement, the character portion 614 shaped by the light blocking layer 612 glows.

Forming the printed layer 611 with a constant printed thickness on the upper face of the frame 610 as illustrated in FIG. 13, however, may increase the size of a step at a perimeter Sb of the light blocking layer 612 covering the printed layer 611, thereby lowering the aesthetic value of the keycap 600.

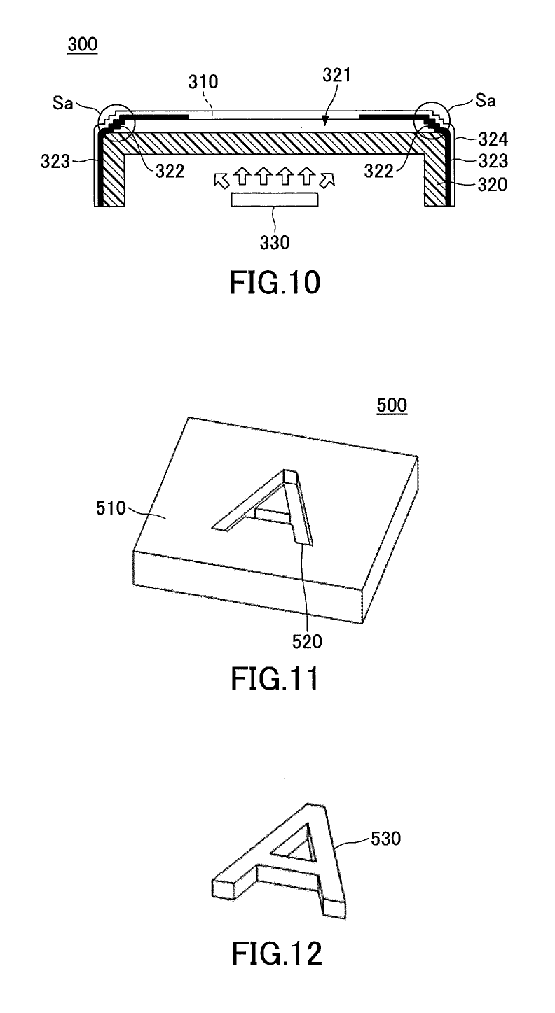

FIG. 9 is a drawing illustrating an example of a keycap 300 according to an embodiment. FIG. 10 is a cross-sectional view taken along the line C-C in FIG. 9.

A keycap 300 illustrated in FIG. 9 and FIG. 10, which is used for a type of keyboard known as a backlight keyboard, has a character portion 310 formed thereon. The character portion 310 allows light emitted from a light source 330 under the keycap 300 to pass therethrough. In FIG. 10, the light source 330 is schematically illustrated. Although an example illustrated in FIG. 10 has a configuration in which the light source 330 is situated under the keycap 300, a different configuration may be used in which a light guide plate or the like for guiding light form a light source situated somewhere else is disposed such as to illuminate the keycap 300 from underneath.

The keycap 300 includes a frame 320, a printed deposit 321, a light blocking layer 323 serving as a coated layer, and a coating layer 324.

The frame 320 is made of a material such as a transparent resin allowing light to pass through. The upper face of the frame 320 has the printed deposit 321 formed thereon to cover the entire upper face of the frame 320.

The printed deposit 321 is formed on the upper face of the frame 320 by a printing method previously described, which uses a printing plate with a recessed area having stair-like steps formed along the perimeter thereof. The printed deposit 321 is made of a print material allowing light to pass through. The printed deposit 321 has stair-like printed steps 322 on the side face thereof as illustrated in FIG. 10.

The light blocking layer 323, which is made of a black paint or the like allowing no light to pass through, is formed to cover at least the printed steps 322 of the printed deposit 321. Specifically, the light blocking layer 323 is formed by applying or printing the paint or the like such as to cover the printed deposit 321 and the frame 320, followed by removing the paint at the position of the character portion 310.

The coating layer 324, which may be made of a material such as a transparent resin allowing light to pass through, is formed to cover the light blocking layer 323 and the printed deposit 321 exposed through the light blocking layer 323.

The keycap 300, which has the configuration described above, allows light from the light source 330 to pass through the frame 320, the printed deposit 321, and the coating layer 324, so that the character portion 310 shaped by the light blocking layer 323 glows. Although the illustrated keycap 300 has a letter “A” formed at the character portion 310, a different character or symbol may be formed, or a plurality of characters or symbols may be formed.

When the printed layer 611 having an even printed thickness as illustrated in FIG. 13 is formed on the upper face of the frame 610, a large step is formed at the perimeter Sb of the light blocking layer 612 covering the printed layer 611. As a result, the step of the printed layer 611 becomes conspicuous especially when the light blocking layer 612 is formed by using a black ink as a print material, thereby undermining the appearance of the keycap 600.

In contrast, the keycap 300 of the present embodiment has the printed steps 322 formed at the side faces of the printed deposit 321, so that the thickness of the printed deposit 321 exhibits gradual stair-like increases. As illustrated in FIG. 10, thus, the height of each of the steps between the printed deposit 321 and the frame 320 is smaller than in the example illustrated in FIG. 13. Accordingly, even when the light blocking layer 323 is formed by using a black ink or the like, the steps at a perimeter Sa of the light blocking layer 323 are made inconspicuous due to the fact that these steps formed by the printed deposit 321 and the light blocking layer 323 are smaller than in the example illustrated in FIG. 13. Aesthetic value thus improves.

When considering the issue of elimination of a step on a keycap, the same or similar functions and advantages are provided even when the keycap of interest is not for a backlight keyboard.

As has been described heretofore, the use of the printing plate 100 of the present embodiment allows a single printing process to readily form a printed deposit having gradation that exhibits stair-like density changes along the perimeter thereof. Further, a substrate such as a keycap with improved aesthetic value can be manufactured.

Although a printing plate, a substrate, and a printing method have heretofore been described according to the embodiments, the present invention is not limited to those embodiments. Various changes and modifications may be made without departing from the scope of the invention.

The present application claims foreign priority to Japanese priority application No. 2015-146071 filed on Jul. 23, 2015, with the Japanese Patent Office, the entire contents of which are hereby incorporated by reference.

### DESCRIPTION OF REFERENCE SYMBOLS

10 plate face
20 recessed area
22 step
30 ink (print material)
31 printed deposit
100 printing plate
200 substrate
201 print object
300 keycap (substrate)
321 printed deposit
322 printed step
323 light blocking layer (coated layer)

1. A printing plate having a recessed area to be filled with a print material to be transferred to a substrate, comprising
at least one step situated in at least part of the recessed area and having a different depth than a bottom face of the recessed area.

2. The printing plate as claimed in claim 1, wherein the step is made by etching.

3. A substrate, comprising:
a printed deposit having at least one step having a different height than a topmost face thereof, the step being situated at least at part thereof; and
a coating layer covering the step.

4. A printing method utilizing a printing plate with a recessed area, comprising:
a depositing step of depositing a print material in the recessed area, the recessed area having at least one step that is situated in at least part thereof and that has a different depth than a bottom face of the recessed area;
a first transfer step of transferring the print material deposited in the recessed area onto a transfer body; and
a second transfer step of transferring the print material transferred onto the transfer body to a substrate to form a printed deposit.
